(19) United States
(12) Patent Application Publication
(10) Pub. No.: US 2005/0180804 A1
(43) Pub. Date: Aug. 18, 2005

(54) System for marking components and for verifying the applied marking

(76) Inventors: Neil Andrew, SHEFFIELD (GB); David James Ray, Sheffield (GB)

Correspondence Address: HARNESS, DICKEY & PIERCE, P.L.C., P.O. BOX 828, BLOOMFIELD HILLS, MI, 48303, US

(21) Appl. No.: 10/508,111

(22) PCT Filed: Mar. 18, 2003
(86) PCT No.: PCT/GB03/01143

(30) Foreign Application Priority Data
Apr. 8, 2002 (GB) 0208040.6

(51) Int. Cl. B41J 29/42; B41J 3/01; B41J 2/22

(52) U.S. Cl. 400/703; 400/74

(57) ABSTRACT

A system for applying a set of marks; and automatically verifying marks is disclosed, having user interface comprising a bar code scanner and a visual display. The system applies a mark to a component, and verifies the machine readability of the mark, without readjustment of marked component An operator is given a simplistic pass/fail indicator for verification. The system features a status monitoring facility whereby a maintenance status of the system is monitored by analysing an image of an applied mark. Automatic alert signals are generated and displayed on the user interface, when the system detects, from an analysis of an image of an applied mark, that machine maintenance is required. The system further features security systems which restrict access for configuration and set up of the system.

### FIELD OF THE INVENTION

The present invention relates to the field of marking, and particularly although not exclusively, to machine readable codes, including but not limited to Data Matrix marks.

### BACKGROUND TO THE INVENTION

Within industry in general, there is a requirement for marking of components, to ensure that parts can be traced to their original manufacturer, to guard against counterfeit parts and to make sure that parts are coded correctly, to make sure that the correct components are fitted, and to guard against fitment of similar or near identical, but incorrect parts during assembly of products.

Different industry sectors, for example automotive, aerospace, computing sectors each have standards for component marking. In the aerospace industry for example, requirements for marking of components are set out in the prior art document Spec 2000 available from the Air Transport Association of America Inc, 1301 Pennsylvania Avenue, Washington D.C 20004-1707. There is a requirement that for some components, where a label is unsuitable because it is not durable or may become detached from the component, that the component itself must be directly marked. Aircraft engine parts in particular are required to be directly marked, if possible, with a machine readable code.

Prior art marking methods for directly marking machine components include dotpeen marking, laser marking, and chemical etching. Direct marking involves making permanent changes to a surface of a part being marked. The requirements for marking aircraft components, in particular engine components are stringent. Throughout the whole life of the component, the marking must remain legible and machine readable. Engine aircraft components in particular undergo severe operating conditions.

Referring to FIG. 1 of the accompanying drawings, there is illustrated schematically in plan view, a prior art Data Matrix mark which has been applied using a dot peening process. The mark comprises a plurality of cells, which may or may not contain dots. Where cells contain dots, these are applied by peening a surface of a component to which the mark is applied. The arrangement of dots contains coded information about the, component to which the mark is applied. The coding includes prior art error correction code (ECC) based upon a known Reed-Solomon coding algorithm or other known coding algorithm. Application of error correction coding enables redundancy of information within the mark, and, depending upon the level of redundancy within the error correction code, allows a proportion of the mark to be obliterated, and yet the information to be recovered from the remaining legible portions of the mark. The proportion of obliteration which can be tolerated depends on the level of redundancy coding within the error correction code. However, even though the Data Matrix mark contains error correction coding, it is still important to ensure that the mark as initially applied conforms to a high level of tolerance and legibility. International Aerospace quality group (IAQG) standard number 9132 published in draft form on Aug. 28, 2001, sets out general requirements and tolerances for dotpeening of Data Matrix marks for the aerospace industry, including requirements for a ‘squareness’ of the mark, a quiet zone margin around a mark, a roundness of surface to which a mark can be applied, a symbol size, and an angular distortion of a mark, as well as parameters for minimum readable cell size by surface texture dot depth, stylus radius, surface colour and colour consistency, stylus cone angle, stylus point finish, stylus point concentricity and dot centre off set.

For aerospace components, compliance with Data Matrix marking specifications is a critical issue. In some cases, applying a mark incorrectly to a component requires that the whole component is scrapped. In other instances, where a concession for remarking is possible for a component, an incorrectly applied mark can be obliterated, and re-marked. However, there are limitations to how many times an incorrect mark can be obliterated and re-marked for single component, depending upon the component type. Application of out of tolerance Data Matrix marks or human readable marks can still lead to scrapping of manufactured components before they are used. For some individual aircraft engine components, the cost of a single components can be as much as US $100,000. Therefore, correct application of a mark and verification that a mark has been correctly applied is an important stage of manufacture.

What is required is to produce a mark of the highest quality with reproducible results, so that subsequently, the marks are capable of tolerating the maximum amount of damage and still remain readable.

There are three stages for ensuring that a mark is correctly applied to a component. Firstly, the mark must be applied within tight tolerance specifications.

Secondly, the mark must be read, and decoded, to check that the mark is readable. Thirdly, it must be verified that the individual tolerances according to specification are complied with.

### SUMMARY OF THE INVENTION

Specific implementations of the present invention aim to provide a marking system in which a component is marked, and immediately after marking, the mark is automatically verified. In a best mode implementation, marking and verification are carried out under control of a single machine to which a component to be marked is mounted.

In one preferred best mode embodiment, operation of the machine by a human operator for producing a run of marks applied to components is made as simple as possible from the operators point of view, by providing for input of commands using a bar code reader, and a visual display device which displays a minimum selection of relevant parameters to enable the operator to perform an integrated marking and verification process. In a configuration mode, commands may be input using a keyboard, and/or a pointing device such as a mouse or track ball and a bar code input may optionally be used as well. In a security mode, an operator can be introduced to the system using a bar code input data identifying the operator.

An operator may make a visual inspection of a mark immediately after application of the mark to a component, in real time, by viewing the mark in an image window displayed on a visual display device.

In the best mode, a marking and verification system operates to perform:
integrated marking and verification using the same system;
reading a mark and verifying a mark in a single system;
using the results of the verification to provide monitoring of a condition of the system, in particular a marking device.

Other features include:
a simple pass/fail indicator to display a result of the verification process; and
a simple warning indicator to indicate when system maintenance is required; and
a set of visual reports detailing diagnostic information concerning the problems, causes and solutions for system maintenance.

The marking and verification are carried out under control of a common control system. A user interface display may be provided, enabling an operator to monitor stages of marking, verification, and machine status monitoring, and to easily determine a result of verification of a mark, and to determine whether machine maintenance is required.

According to a first aspect of the present invention, there is provided an integrated component marking system comprising:
a marking device for applying a mark directly to a component;
an image capture device for capturing an image of said mark;
a verification device for verifying an integrity of said mark, and
a common control system for controlling said marking device, said image capture device and said verification device.

According to a second aspect of the present invention, there is provided an integrated method of applying a mark to a component, and verifying said mark, said method comprising:
applying said mark to said at least one component;
capturing an image of said applied mark; and
verifying whether said mark is within a specified tolerance;
wherein said processes of applying said mark, capturing said image, and
verifying said image are carried out by a common control system.

According to a third aspect of the present invention, there is provided an integrated method of applying a mark to a component, and verifying said mark, said method comprising:
inputting a set of marking data to be applied in the form of a mark to at least one component;
applying said mark to said at least one component;
capturing an image of said applied mark;
analysing said captured image to verify whether said mark is within a specified tolerance; and
analysing said captured image to determine a maintenance status of said apparatus.

According to a fourth aspect of the present invention, there is provided a control system for a combined marking and verification apparatus, said operating system comprising;
a control application for controlling overall operation of said apparatus;
a bar code processor capable of receiving bar code inputs for control of said apparatus;
a security component, capable of authorising an operator of said apparatus;
a verification component capable of verifying a mark applied by said apparatus;
a system condition component capable of monitoring a maintenance condition of said apparatus; and
a database for storing data for operation of said apparatus.

According to a fifth aspect of the present invention there is provided a configuration method for configuring a component marking system to apply at least one mark to a component, and to verify said mark, said method comprising:
inputting a set of data variable types to be included in a set of marks;
positioning an image capture device to capture an image of a mark;
performing a verification operation for verifying a machine readability of said mark.

According to a sixth aspect of the present invention, there is provided a security method for controlling operation of a marking apparatus capable of applying a mark to a component, said method comprising;
storing a set of operator identfications, each having a corresponding set of privileges for enlisting different operator of said apparatus to be performed;
inputting a bar code signal identifying an operator;
comparing said operator identification signal with said set of stored operator identification signals,
enabling said apparatus to operate according to said corresponding set of privileges corresponding to said input operator identification signal.

The invention includes an interface display for operating a marking and verification apparatus for applying at least one mark to at least one component, and for verifying said applied at least one mark, said interface comprising;
a pass/fail indicator for indicating a result of a verification process;
an image view for viewing an image of said applied mark; and
a data display for displaying a marking data, subject of said applied mark.

The invention includes an interface display for configuration of a marking and verification apparatus, said interface comprising;
an image display for displaying an image of said applied mark;
a positioning interface for positioning an image capture device to capture said image of said applied mark; and
a mark content display for displaying a set of data variables, for inclusion in a set of marks.

According to to seventh aspect of the present invention, there is provided a method of monitoring a maintenance condition of a marking machine, said method comprising:
capturing an image of a mark applied to a component;
analysing said captured image to determine whether said mark is within a set of specified limits, within which said machine is operating without the need for maintenance; and
if said analysis results determine that said mark is outside said specified limits, generating at least one message indicating that machine maintenance is required.

Further features of the invention are as recited in the claims herein. The scope of the invention is limited only by the scope of the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 Illustrates schematically a prior art Data Matrix mark comprising a grid of dot indentations, encoding a set of data parameters describing a component;

FIG. 2 Illustrates schematically a marking and verification machine and system according to a best mode implementation of the present invention;

FIG. 3 Illustrates schematically a marking and viewing device comprising the marking and verification machine of FIG. 2;

FIG. 4 Illustrates schematically a control system for controlling operation of the marking and verification machine of FIG. 2;

FIG. 5 Illustrates schematically a logical view of components of the control system;

FIG. 6 Illustrates schematically positioning of a marking and viewing device for carrying out a marking operation of a component in a first position;

FIG. 7 Illustrates schematically a second positioning of the marking and viewing device for performing an image capture operation of an applied mark;

FIG. 8 Illustrates schematically a marking process for marking a single component;

FIG. 9 Illustrates schematically a verification process for verifying a readability of a mark applied to a component;

FIG. 10 Illustrates schematically a use model followed by an operator of the marking and verification device for marking a component;

FIG. 11 Illustrates schematically a marking and verifying interface display used by an operator during a marking process for applying a mark to a component;

FIG. 12 Illustrates schematically a set of bar code commands used by an operator for controlling operation of said marking and verification machine;

FIG. 13 Illustrates schematically a configuration interface for use by an operator to configure said marking and verification machine for applying a run of marks to a set of components;

FIG. 14 Illustrates schematically operation of said marking and verification machine in a configuration mode;

FIG. 15 Illustrates schematically a layout of a diagnostic report following a verification process of a mark and following analysis of verification data to determine a maintenance condition of the system;

FIG. 16 Illustrates schematically a set of bar code data types comprising the marking and verification system;

FIG. 17 Illustrates schematically a process for inputting a set of bar code variables or commands for operation of said marking and verification system;

FIG. 18 Illustrates schematically fields of data stored within a database comprising said marking system;

FIG. 19 Illustrates schematically individual tolerance parameters according to a tolerance specification for applying a Data Matrix mark;

FIG. 20 Illustrates schematically a deviation from an ideal mark layout of a Data Matrix mark, showing an angle of distortion parameter;

FIG. 21 Illustrates schematically processes carried out by a control application for initiating a verification process for verifying machine readability of a mark;

FIG. 22 Illustrates schematically in overview, status monitoring process for analysing a Data Matrix mark and determining whether said marking and verification machine requires maintenance, depending upon an analysis of a mark applied by said machine; and

FIG. 23 Illustrates schematically an overall control mode implemented by a control application for controlling overall operation of said marking and verification machine.

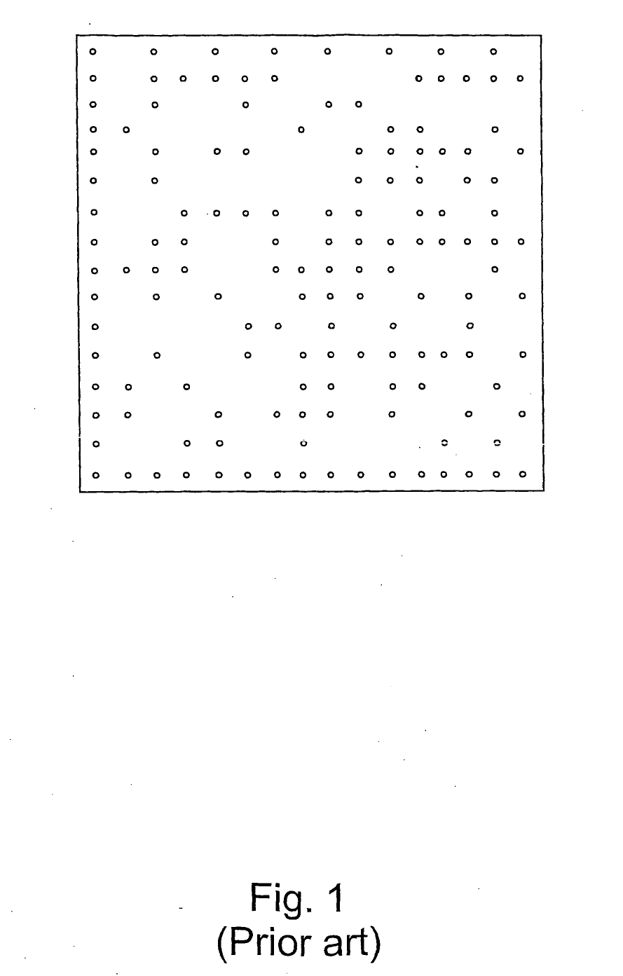

### DETAILED DESCRIPTION OF THE BEST MODE FOR CARRYING OUT THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

Specific implementations according to the present invention provide for an integrated marking and verification system for applying marks to components, in particular Data Matrix marks, and performing viewing and verification of those marks immediately after application of the marks, in an automated and integrated marking and verification operation.

A component to be marked is held firmly in a mounting device, and a marking tool is applied to the component, to create a mark. An operator can view an image of the mark on a visual display device in real time as a camera is positioned adjacent the mark. The camera device is positioned immediately adjacent the mark, to check that a correctly focused, and optimized image of the mark is captured by the camera device.

A verification component reads the mark, and confirms an information content of the mark by displaying this on a display device.

The verification component scans the image data captured by the camera, and analyses the image data, checking that the image of the mark complies with spatial tolerance limits according to a specification data.

Depending upon a result of a comparison between the specification data, and the image of the mark, the mark either passes of fails the verification process. A display of a pass/fail indicator is made on a visual display device.

A system condition component analyses the image data of the mark, to determine a status of the marking device, and to indicate whether maintenance of a marking device is required, and/or whether the marking device is malfunctioning. By analysing the image data of marks produced by the marking device, the system condition component alerts the operator to a maintenance requirement of the machine or a malfunction of the machine, enabling the operator to take corrective maintenance action to the system, before proceeding to mark any further components. Diagnostic data is accessible vie the visual display device, when a maintenance alert signal is displayed, or when the mark fails a diagnostic test.

Operators of the system must be authorised, and the system comprises a security component which determines whether a particular operator is authorised to operate the system, and to restrict functions which the system can carry out, depending upon a level of authorisation of an operator.

Operation of the system at run time for producing marks is controlled optimally by use of a bar code interface, and by reading a set of bar code commands. During configuration, the system can be controlled using a keypad and pointing device, in conjunction with a configuration interface display.

There will now be described in detail, a specific marking and verification system and method of operation of the marking and verification system and a marking and verification method, according to a specific implementation of the present invention.

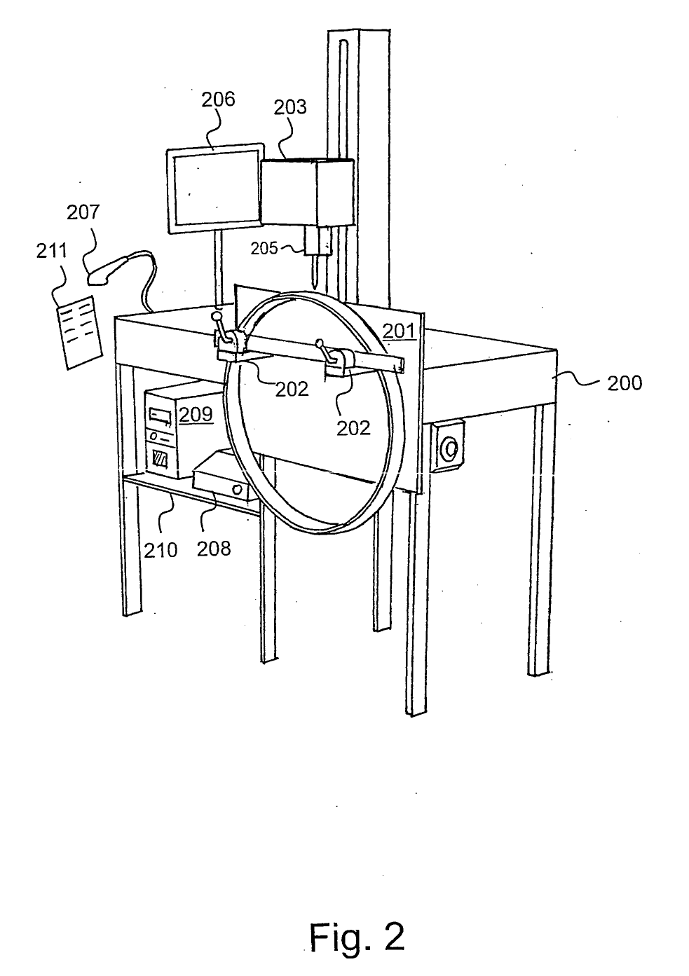

Referring to FIG. 2 herein, there is illustrated schematically in perspective view a marking and verification machine according to a first specific implementation of the present invention. The machine comprises a rigid chassis structure 200; mounted to the chassis structure, a component mounting 201, suitable for securing a component rigidly to the chassis, without damaging the component, the mounting comprising one or plurality of vices 202 of other suitable fixings for securing the component; a marking and viewing device 203, the marking and viewing device capable of holding a marking tool 204 for marking a component when secured in a tool holder device 205, and for viewing a mark once it has been applied to the component; a visual display device 206 for displaying a set of screen views comprising a user interface of the system; a bar code reader device 207 for inputting a set of bar code commands for operation of the system; a drive unit 208 for driving the marking and viewing device 203; a computer control device 209 for controlling operation of the visual display device bar code reader and; marking and viewing device, the drive unit 208 and computer controller 209 being housed in a compartment 210 comprising the chassis 200. The machine further comprises a keyboard and pointing device (not shown) for entering data and commands during a configuration phase.

The marking system further comprises a set of bar code commands 211 which may be printed on a sheet material, and which can be offered up to the bar code reader 207 for entering individual selected commands into the controller 209.

In general, once a mark is applied to a component, an image capture device, typically a digital camera capable of capturing a digital image data, is moved to a position directly above the applied mark. In various embodiments of a marking system, options for mounting a component, and positioning the component relative to a marking device and an image capture device include:

Firstly, mounting the component securely and maintaining the component stationary in a first position relative to the marking and viewing device, during a marking stage and then during a verification stage the marking and viewing device is then moved such that an image capture device which captures an image of the component is held in a position to view the component, and the marking and viewing device adopts a second position with respect to the component.

Secondly, maintaining an image capture device and a marking device stationary, and mounting the component on a moveable mounting, so that the component is placed in a first position for application of a mark and then moved to a second position where it can be viewed by the image capture device, with movement between the first and second positions being automated.

Thirdly, maintaining a marking device and an image capture device stationary, mounting a component to a moveable mounting; positioning the component in a first position under the marking device for application of a mark; moving the component to a second position adjacent the image capture device for image capture, where movement between the first and second positions is not carried out automatically and may require manual intervention.

In all cases the marking and verification stages are carried out as an integrated process under control of a single control system.

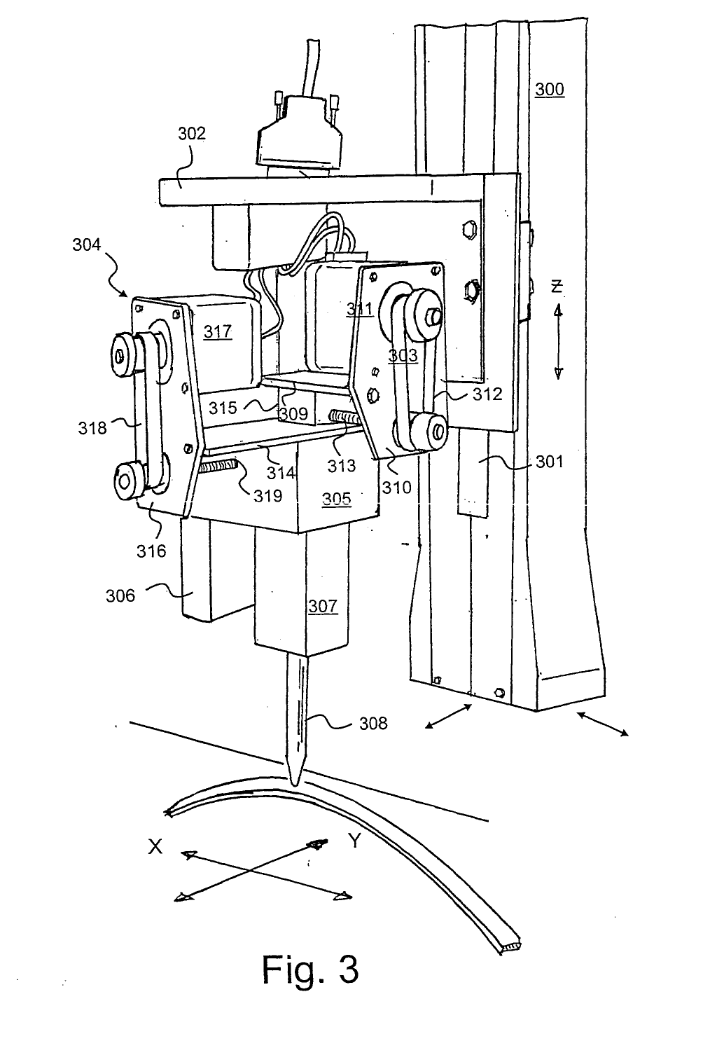

Referring to FIG. 3 herein, there are illustrated components of the marking and viewing device. An external cover of the marking and viewing device is shown removed in FIG. 3, to illustrate construction of the device. The marking and viewing device comprises an upright moveable column support 300, comprising an upright track 301, upon which is mounted a gantry 302, such that the gantry 302 can be moved up or down in a vertical direction; suspended from the gantry, a first carriage mechanism 303 movable with respect to the gantry along a first horizontal line of movement (X); a second carriage mechanism 304, the second carriage mechanism mounted underneath the first carriage mechanism, and capable of movement along a second horizontal line of movement (Y), wherein the first and second horizontal lines are transverse to each other, and in the embodiment shown are perpendicular to each other; a mounting plate 305, the mounting plate secured underneath the second carriage mechanism; a camera device 306 secured to the mounting plate 305; a tool holder 307; secured to the mounting plate; and a peening tool 308, mounted within the tool holder.

The first carriage mechanism 303 comprises a first base plate 309 disposed horizontally in a first horizontal plane, the first base plate having attached a first end plate 310, mounted upon the first end plate 310, a first motor 311 and first belt drive mechanism 312 for driving a first worm screw 313. The second carriage mechanism comprises a second base plate 314, the second base plate having a threaded block 315 securely attached thereto, the threaded block attached to slide in a first horizontal line backwards and forwards, under power from the first worm drive, such that the second carriage mechanism can be slid horizontally along the first line of movement by driving the first motor backwards or forwards, and thereby driving the first worm drive 313 backwards or forwards; a second end plate 316, the second end plate carrying a second motor 317, and a second belt drive mechanism 318 for driving a second worm drive 319. The mounting plate 305 located underneath the second base plate has a threaded bore which accepts the second worm drive, such that rotation of the second worm drive backwards or forwards produces a corresponding forward or backward motion of the mounting block, along a second horizontal line, wherein the second horizontal line is transverse to the first horizontal line. In a best mode implementation, the mounting block is arranged to move along a line of movement which is perpendicular to a line of movement of the second carriage, and underneath the first carriage way.

The gantry is driven up or down the column under power of a third motor. The column as a whole is driven in a translational movement with respect to a component, such that movement of the whole column moves the marking and viewing head so that in a first position of the column relative to the component, the marking and viewing head presents the marking toll to the component, and in a second position of the column relative to the component, the marking and viewing head presents the camera to view a position of a marking site on the component. The first and second carriages enable fine placing of the peening tool to apply individual dots of a mark.

By applying control signals to the first, second, third, and fourth motors, and by moving the gantry in a vertical line upwards and downwards, accurate three dimensional positioning of the peening tool 308 can be achieved with high precision of movement.

The upright column 300, the gantry and its mounting to the column, the first carriage and first worm drive mechanism, second carriage and second worm drive mechanism and mounting plate are engineered to fine engineering tolerances, such that the peening tool, can be moved such that a point of the peening tool can produce a series of impact holes in a surface of a work piece with a high degree of accuracy.

Typically, for a two dimensional Data Matrix marked on a surface of a component, all dot symbols are contained within an area 5.0 mm×5.0 mm. Therefore, individual dots need to be placed with a high degree of accuracy, for example, in the case of a 16×16 array, within an accuracy of approximately 0.02 mm. The gantry, carriages, mounting plates and column are engineered to have tolerances enabling placement of the peening tool to such a degree of accuracy.

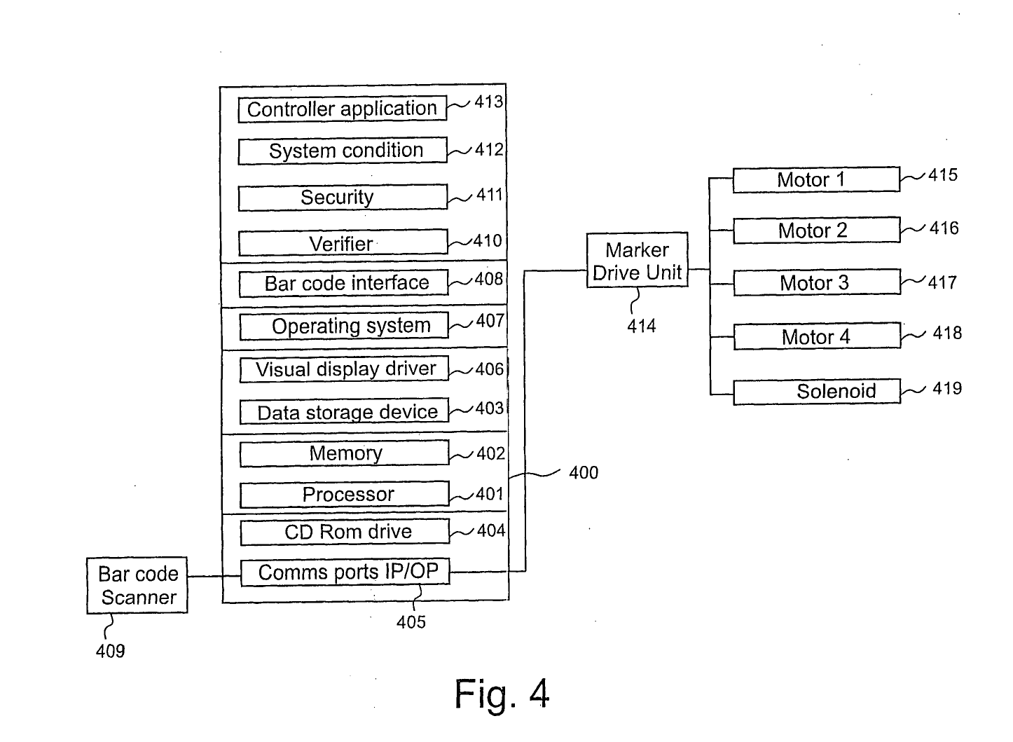

Referring to FIG. 4 herein, there is illustrated schematically components of the controller and marker drive unit for controlling operation of the marking system. Controller 400 comprises a data processor 401 of known type, for example an Intel® processor; a known memory device 402; provided on a same card as the processor; a known data storage device 403, for example a hard disk data storage device, for storing data and one or more application programs; a data input device 404, for example a CD ROM drive; one or more communications ports 405 for communicating with external devices such as a bar code scanner and the marker drive unit; a visual display driver 406 for driving a visual display device; a known operating system 407, such as a Linux®, Unix® or Microsoft Windows®, operating system; a bar code interface 408 for inputting commands from bar code scanner 409; a verifier component 410 for verifying the accuracy of produced marks; a security component 411 for controlling access to the system and for apportioning authorisations and privileges to different users of the system; a system condition monitoring component 412 for monitoring an operational status of the marking and viewing device; and a controller application 413 for carrying out overall control of the system.

The system further comprises the marker drive unit 414, which produces signals to first, second, third and fourth motors 415 to 418 respectively for controlling positioning of the column first carriage, second carriage and gantry along respective mutually orthogonal lines of movement X,Y,Z; and a solenoid 419 comprising the tool holder for activating a peening stylus comprising a peening tool.

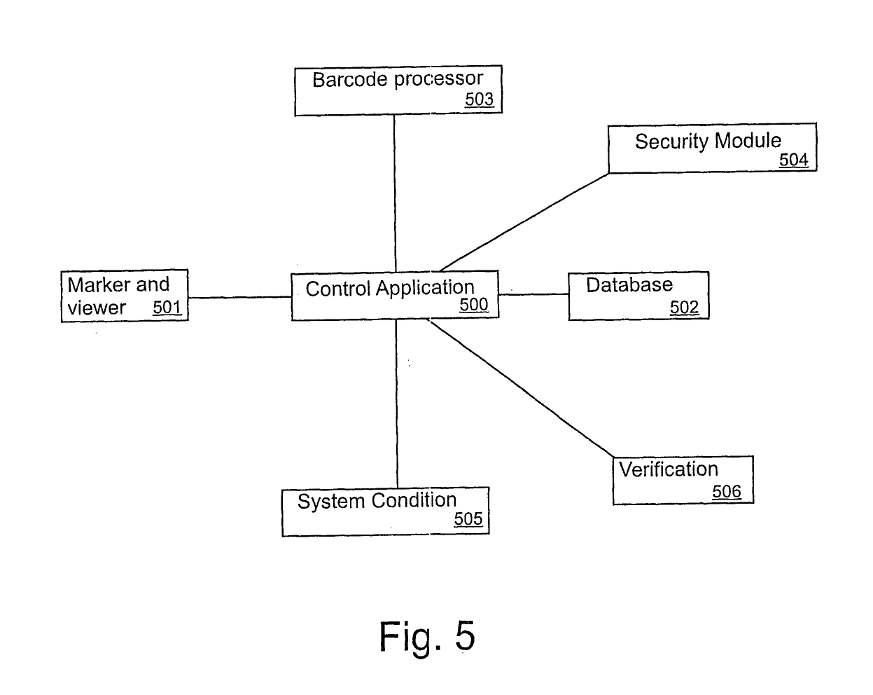

Referring to FIG. 5 herein, there is illustrated schematically a logical relationship between individual components of the marking system of FIGS. 2 to 4 herein.

Control application 500 controls overall operation of the system, and communicates with the marking and viewing device 501 for applying marks to components to be marked, and viewing those marks once produced, the marks being produced according to a component marking scheme which is stored in database 502. The scheme may comprise a set of sequentially incremented part numbers, serial numbers, batch numbers and manufacturer numbers depending upon the components being marked.

Control application 500 receives commands from bar code processor 503 input by an operator from a sheet of pre-determined printed bar codes, each bar code command representing a command to the system for performing a pre-determined operation, for example marking, performing a verification; or performing a system condition check to check a maintenance condition of the marking system; or for authorising a new operator or replacement operator to operate the system; or for configuring the system.

Control application 500 communicates with security module 504 for authorising operators of the system, through reading of bar codes via bar code processor 503; and for authorising different levels of personnel, to carry out different functions including configuration of the system.

Security module 504 allows the system to distinguish between different authorisation levels of human operator, and to trace the actions which that operator has carried out using the system.

System condition component 505 inspects an image view generated by the camera, showing a produced mark, and applies a set of algorithms to check whether individual dot indentations comprising the mark are within a tolerance specified by a set of tolerance data, and generates an alert signal if the mark is either outside predetermined tolerance limits, or outside pre-determined tolerance limits, but still within a tolerance specification.

Verification component 506 inputs an image data of a produced mark, reads the information within that mark, decodes the mark, and verifies that the mark is machine readable.

Bar code component 503 operates for inputting and reading bar code commands and input variables.

Database 502 stores data for each mark applied describing a time and date, an operator, an information marked, a verification results data, and whether a maintenance warning is issued for that mark.

Various modes of operation of the marking system will now be described, illustrating in further detail, the functionality of the marking system.

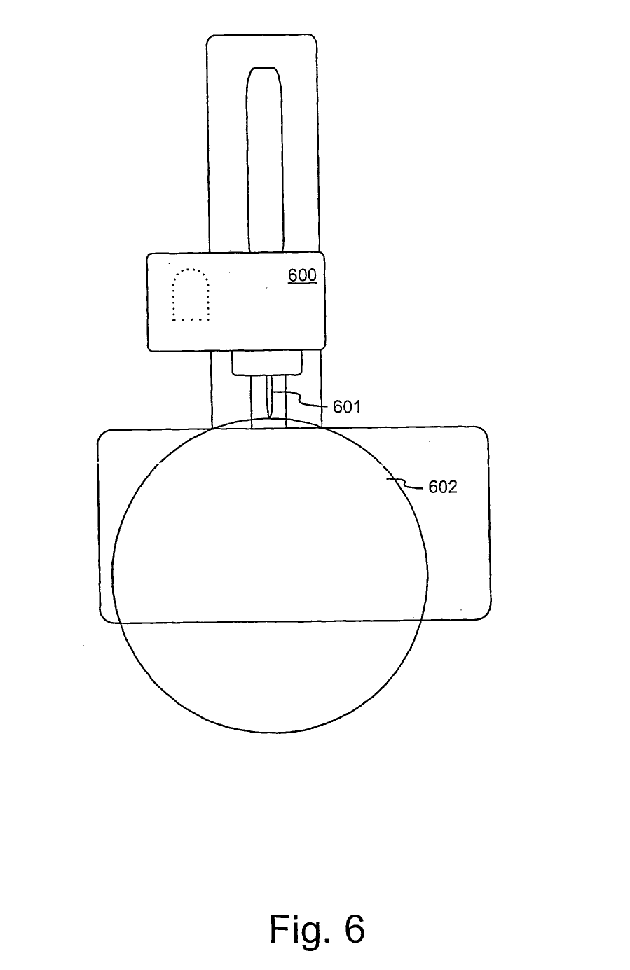

Referring to FIG. 6 herein, there is illustrated schematically operation of the marking and viewing device during a marking phase. The marking and viewing device 600 is positioned such that marking tool 601 is close to a component 602 to be marked. The marking device proceeds to apply a mark comprising a series of peened dots to a surface of the component.

The system operates to apply a mark to a component, and then immediately after application of the mark, position the camera over the mark, to enable verification of the mark. In the best mode implementation, the mark is verified according to the International Aerospace Quality Group Standard, although in the general case, a mark complying with any set of marking specifications can be verified. Direct marking of components is combined with verification of that marking in a single operation, without removal of the component from the marking system, and both operations being carried out by the same system as described herein.

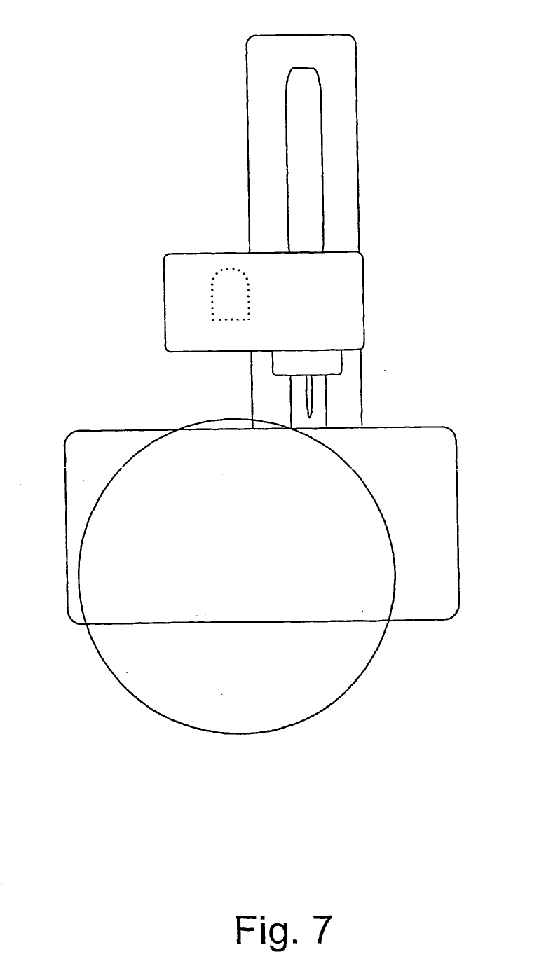

Referring to FIG. 7 herein, there is illustrated schematically positioning of the marking and viewing device during a viewing and image capture operation, performed immediately after a marking operation. To perform the viewing operation the controller controls the column to move relative to the chassis by a horizontal transitioned movement, causing the marking and viewing device to be moved, by controlling the fourth motor, to move the column such that the camera is positioned directly over the mark. A video image of the mark can be viewed in real time on the visual display device by an operator, during the viewing operation.

It is important when verifying the mark, that reproducibility of images of marks can be maintained, and that the verification component is not affected by variations in ambient light, variations in parallax, variations in different distance of the camera between different marks, and other deviations from a pre-set view of the mark from a pre-set position of the camera. Reproducibility of the view is achieved by pre-setting a viewing position of the camera for a particular component type, during a configuration stage of the system, and storing this pre-set viewing position as control data within the database, which is applied by the control application upon selection of a component type

The camera device may comprise a prior art camera, including a software module which decodes a Data Matrix mark. Such cameras and software are available commercially.

By using the results of the verification to assess machine condition, it can be determined whether the marking device is worn. If the marking device is developing mechanical wear, individual dot impacts will be slightly off centre, or have other aberrations which can be detected by the system, and which the system condition component can use to alert an operator that maintenance of the system is required, thereby avoiding application of faulty marks to components.

Mechanical wear which can be monitored includes;
displacement of dots from their nominal positions within a cell gridline;
a chipped stylus of a peening tool, resulting in a difference in surface area of a dot produced by the stylus;
blunting of a stylus of a peening tool, resulting in an increase in area of a dot produced by the blunted stylus.

Limitations on dot placement and shape which result from all the above errors can be predetermined, and currently produced marks monitored against those pre-determined tolerance limits to determine whether maintenance of the system is required.

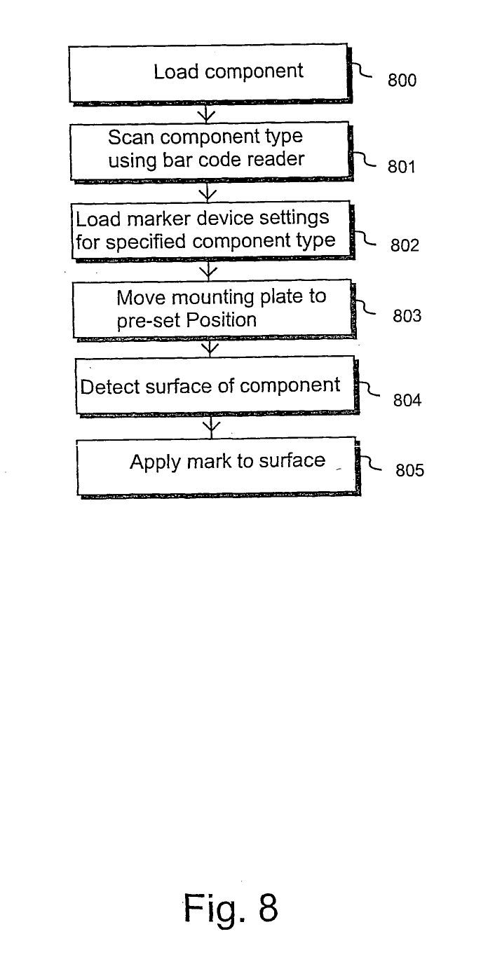

Referring to FIG. 8 herein, there is illustrated schematically in overview, steps carried out by the marking system for marking a component. In step 800, an operator loads the component onto the mounting device, and secures the component in place using clamps or other securing devices. In step 801, the operator picks up the bar code reader, and scans a bar code from a sheet of bar codes, the scanned bar code corresponding to a data describing a type of component to be marked. In step 802, a plurality of settings for the marker device are loaded from the database by the control application. The settings are input into the marking and viewing device. The settings comprise a set of position data for positioning the marking tool immediately above the component, at a place on the component which is to marked, as well as a set of data to be applied to the component in the form of a mark. The data may include a manufacturer number; a part number; a serial number, and a batch number. The configuration settings are pre-set by an operator in a configuration mode.

In step 803, the tool is moved to the pre-set position, by applying signals to the first, second, third and fourth motors controlling the horizontal and vertical movement of the mounting plate carrying the tool holder and tool. In step 804, the marking device undergoes a pre-set routine of moving the tool towards the component, in order to detect a surface of the component. Once the surface of the component is detected, this is used as datum, enabling the marking device to determined the position of the surface. In step 804, the marking device proceeds to apply a mark containing the information for the specified type of component, by applying a series of dot impacts using a solenoid driven stylus comprising the marking tool. The marking tool is moved in first and second horizontal directions X, Y respectively, applying dots according to the information coded within mark to be applied.

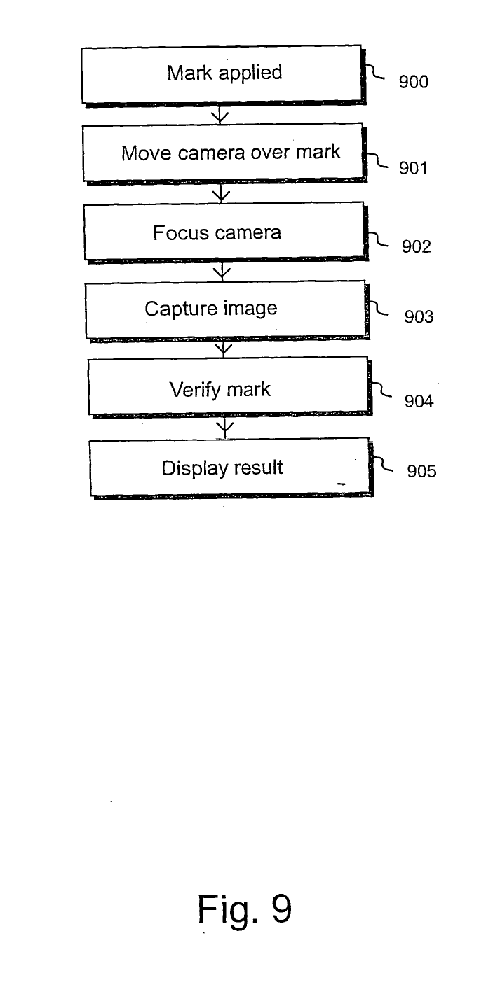

Referring to FIG. 9 herein, there is illustrated schematically steps carried out by the marking and viewing device for viewing a mark once applied in step 900. In step 901 the mounting plate is moved, by means of a translational movement of the column, and a vertical movement of the gantry along the column, to place the camera directly over the mark, in accordance with pre-determined configuration data stored in the database for the type of component which has been marked. The camera is placed in a position in which it is already focused on the surface of the component, according to pre-stored configuration data set up for the particular type of component being marked. However, an operator can jog the camera in steps to refocus the camera, viewing an image of the mark on the visual display screen in real time. In step 903, an image of the mark is captured, initiated by a bar code command read in by the operator. In process 904, the mark is automatically verified, by analysis of the captured image data of the applied mark. Verification of the mark may be initiated by reading a bar code command using the bar code scanner. A result of the verification is displayed on the visual display device in step 905. The result can either be that the mark is within the specified tolerance limits or, is outside the specified tolerance limits.

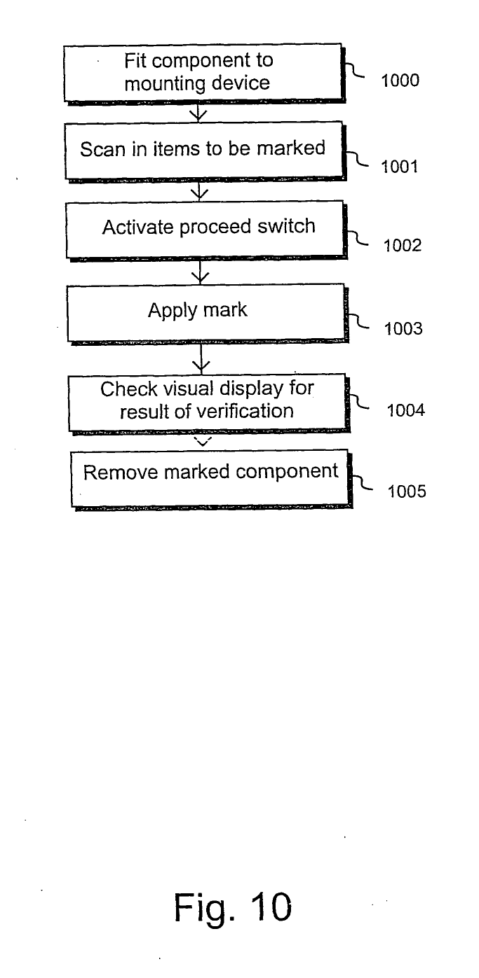

Referring to FIG. 10 herein, there is illustrated schematically a use model detailing steps carried out by an operator for marking a component. In the best mode implementation, during marking and verification, the machine is operated by bar code commands. In step 1000, the operator fits the component to the mounting device, clamping the component or otherwise securing the component by means of a securing device particular to that type of component and which can be varied according to different component. In step 1001 the operator, having satisfied themselves that the component is rigidly and securely mounted, selects data items to be marked on the component by selecting corresponding respective bar codes from a bar code menu, which may be provided as, for example, an A4 printed sheet having a plastics laminated cover. The operator may scan in more that one item to be marked. Each item to be marked may be displayed on a marking display which can be viewed on the visual display device. Once the operator is satisfied with the individual items to be marked, and has checked the visual display device, the operator proceeds to activate a switch, which initiates marking. The system then proceeds to mark the component and verify the mark as described herein before. On termination of verification, the system displays a result of the verification. In step 1003 the mark is applied. In step 1004, the operator checks the visual display for the result of the verification. In step 1005, the operator removes the marked component, and depending upon the result of the verification, either re-commences the whole operation for marking a further component, or, if the result of the verification is that the mark is out of specification, the operator may call a maintenance personnel to rectify any defects in the system.

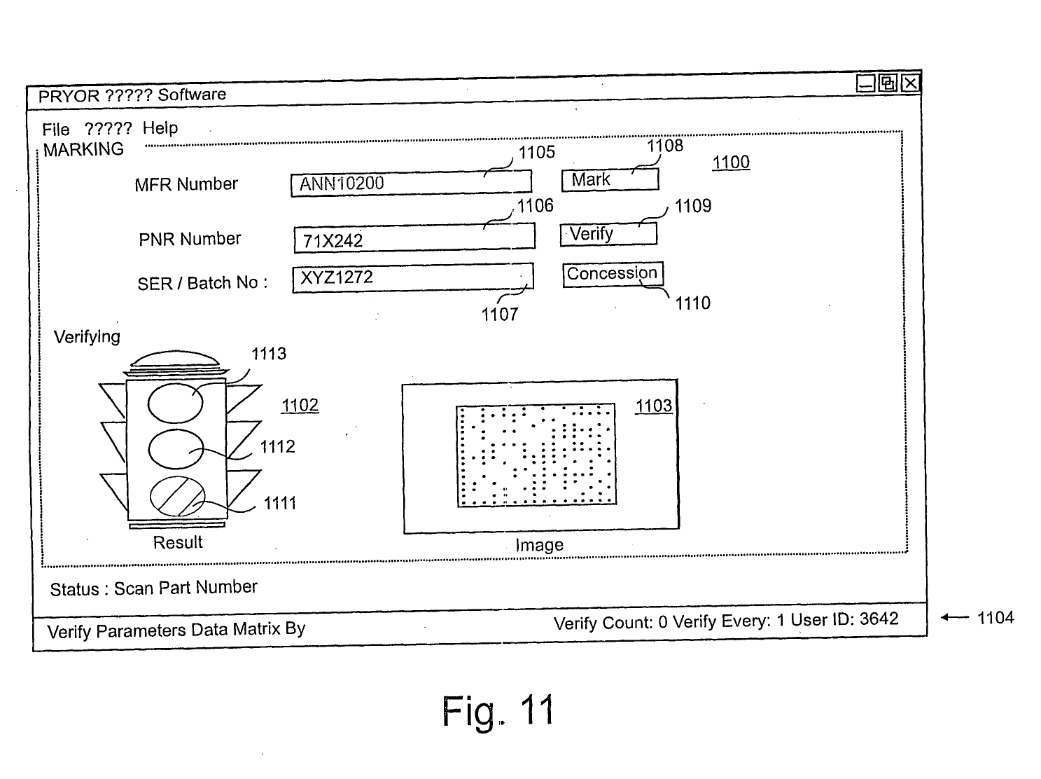

Referring to FIG. 11 herein, there is illustrated schematically a marking and verification display interface generated by the system. The marking and verification display comprises a first area 1100 containing data describing items to be marked and/or items which have been marked on a component; a second area 1102 comprising a verification result indicator display for displaying a result of a verification process; a third area 1103 for displaying an image of the mark as viewed by the camera; and a fourth area 1104 which optionally displays selected parameters which are to be verified, or have been verified by the system.

In the example shown, the first area 1101 comprises a first text window 1105 for displaying a manufacturer number; a second text window 1106 for displaying a part number; a third text window 1107 for displaying a serial number or batch number of a component; a ‘mark’ icon 1108; a ‘verify’ icon 1109; and a ‘concession’ icon 1110.

The second area comprises an indicator for indicating a result of a verification process. In the best mode implementation the indicator has three levels of indication. Firstly, that the mark has passed the verification process, indicating that the mark is within the tolerance parameters according to the specification; secondly, a ‘warning’ level 1112 indicating that the mark is readable, but is outside specified tolerance limits. In this case maintenance of the machine will result in an improved quality of mark, and failing to maintain the machine may result in a next mark failing the verification test. Thirdly, a ‘fail’ indicator 1113 indicates that a mark is unreadable by the system. In this case, the component may need to be scrapped, or re-marked, depending upon whether re-marking can be tolerated for that particular type of component. Further, when the ‘fail’ or warning results are displayed, the operator should immediately initiate maintenance of the marking and verification machine, to avoid repetition of out of specification marks. In the best mode implementation, the three levels of indication are conveniently displayed as a traffic light signal having green, amber and red indicators for indicating the three levels of pass, warning and fail results of the verification test.

The third area 1103 comprises a video image which displays in real time image data captured by the camera of the mark. This allows the operator to view the mark, and to determine whether a fail verification result is in fact due to the camera being out of focus, rather than due to the mark having been out of specified tolerance limits. In some circumstances where the camera is incorrectly focused, this can lead to the verification process generating a fail result, for a mark which is within a specified limit. The operator can spot this condition by by viewing the displayed image, and can determine whether to re-apply the verification stage, after having first re-focused the camera. In this case, after re-focusing the camera, the operator may select a ‘verify only’ bar code command from the bar code command menu, in order to re-apply the verification process. In some cases, where the mark originally failed the verification test due to the camera being out of focus, a mark which is within specified limits may pass the verification test for second time. However, where the camera is perfectly focused, the verification process may again result in a fail, which means that the mark has failed the test for a second time.

The fourth area 1 104 comprises a list of selected specification data given as numerical values. The particular data items selected for display may be pre-configured during a set up mode of the system, for a particular type of component. The fourth area also displays other data items, such as a user identification data 1106, a verification counter 1107 indicating a number of times an individual mark has been attempted to be verified; and a verification instruction command, in the example shown specifying that every mark is verified on every individual component marked. The system can be configured to verify only selected marks, for example every alternate mark applied, or for example, every tenth mark, in order to increase throughput of marks applied by the system. For high costs components, where it is expensive to have a failed mark on even a single component, every component may be specified to have its mark verified. For higher volume lower cost components, where re-marking is possible, the system may be configured as part of the configuration settings, to verify only every fifth mark for example, so that throughput of marking can be maintained whilst still retaining some acceptable level of checking that the marks are being applied correctly, are within specified tolerance limits, and without wasting too many components under conditions where marks become out of tolerance.

The status display 1104 displays parameters of the marker and viewing device, enabling an operator to see which particular parameters are tending towards an out of limit condition, when the amber indicator is displayed.

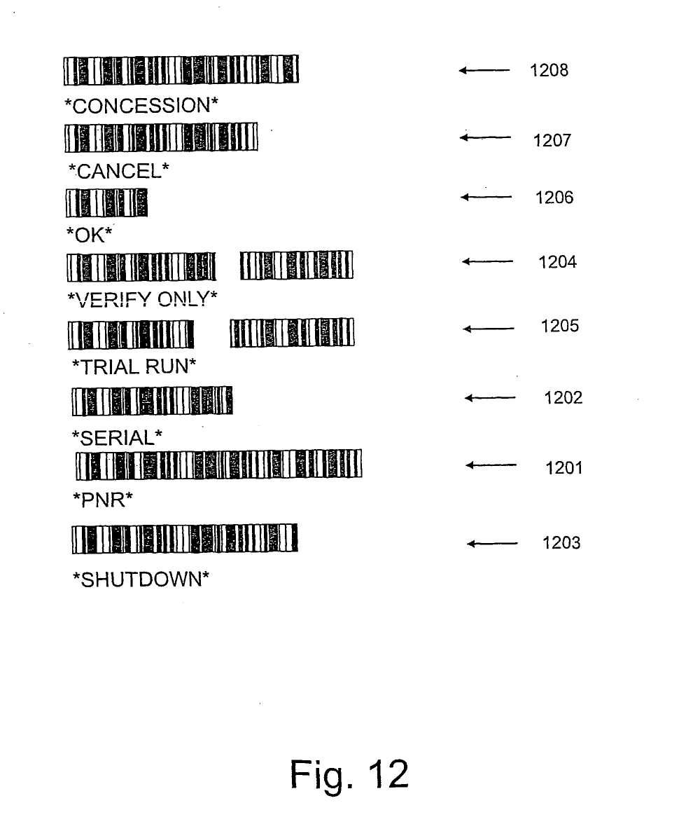

Referring to FIG. 12 herein, there is illustrated schematically a command sheet, comprising a plurality of individual bar codes and for each bar code, a text data identifying the purpose the bar code, which are used as input commands into the marking and verification system. In the example shown, a part number bar code 1201 when read, causes a part number to be selected for inclusion in a mark; a serial number code 1202 when read by the operator causes the system to be configured for a serial number to be included in a mark to be applied to a component; a ‘shutdown’ bar code command 1203 instructs a shutdown of the system; a ‘verify only’ command 1204 allows an operator to select verification only of an already applied mark, which may be used for example to re-verify a mark which has failed the verification test; a ‘trial run’ command 1205 enables an operator to perform a trial run for marking and verification, without actually applying a mark, and causes the marking and verification device to position the marking tool adjacent a component, in order that the operator can gauge a correct position for mounting of a component and perform a trial run without actually marking a component; an ‘OK’ command 1206 allows the system to proceed to apply a mark and perform a verification process; a ‘cancel’ command 1207 cancels a previously selected item, for example a serial number command, or part number command; and a ‘concession’ command 1208 allows a mark which is unreadable or out of specification to be obliterated. The concession command may be used where particular components are permitted to be remarked if an out of specification mark is applied. Typically this involves obliterating the out of specification mark by applying a grid of dot impacts over the whole area of the mark, and then remarking the same component at an adjacent position with a new mark.

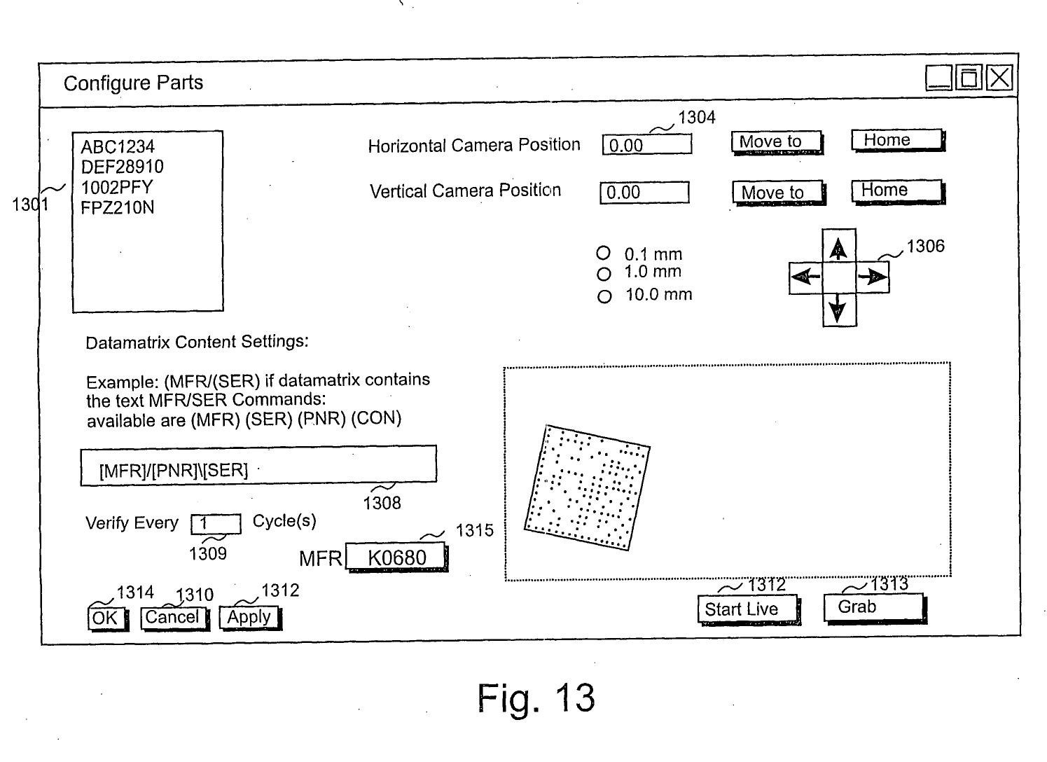

Referring to FIG. 13 herein, there is illustrated schematically a configuration display presented on the visual display device, through which an authorised operator can configure the system to mark and verify a particular type of component. The screen comprises a component number list 1301, from which a component type identification data can be selected. The example window 1301 shown lists a plurality of different parts of numbers already entered into the system; a video image window 1302 for displaying a view of a mark on a component, and/or an unmarked component surface, a camera positioning control section 1303 comprising a first data entry window 1304 for entering a horizontal camera position, a second data entry window 1305 for entering a vertical camera position; a set of camera movement icons 1306 for moving the camera in first and second opposite directions along a first line of movement of the camera and for moving in third and fourth opposite directions along a second line of movement of the camera, with an increment of movement being selected by a plurality of step size selector icons 1307; a content setting data entry window 1308 into which a text string may be, for configuring an information content of a mark to be applied by the system; a verification frequency data entry window 1309 for entering a frequency at which markings should be verified, in the example shown there is selected that every mark produced is verified; a cancel icon 1310 for canceling a data which has been input; a confirmation icon 1311 for confirming configuration data input into the screen; an ‘apply’ icon 1312; a ‘start live’ icon 1313 for moving the camera in real time; a ‘grab’ icon 1314; and a manufacturer number display 1315.

By triggering the movement icons 1306, the camera can be moved around the image, to check visually in the image display screen, that the mark remains in focus in and around the immediate area of the mark. Once the operator is satisfied with the focus, the operator can click the ‘OK’ icon 1304 to save those camera position settings.

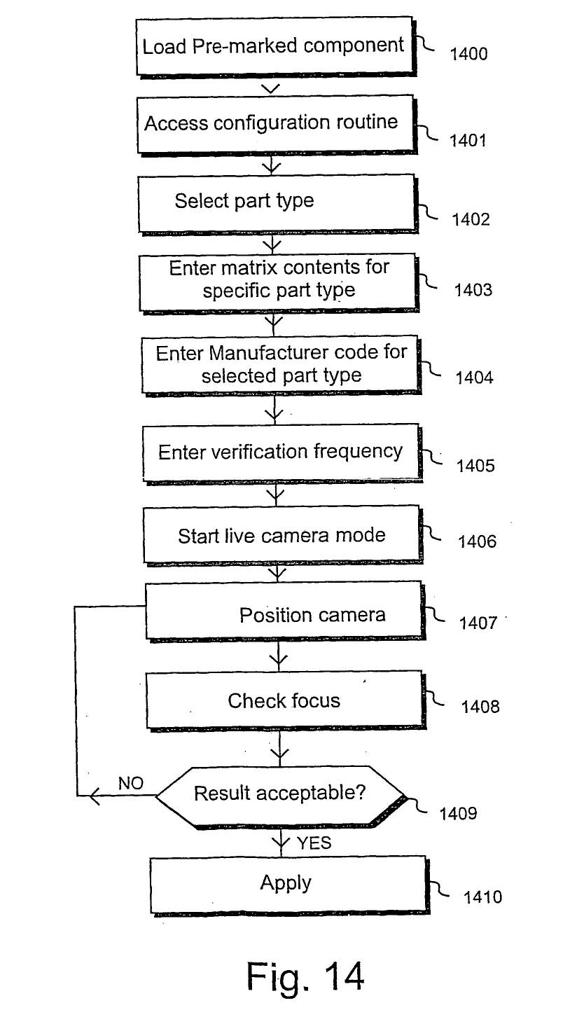

Referring to FIG. 14 herein, there is illustrated schematically process steps carried out by the system under guidance of an operator for configuring the system to mark and verify components. During a configuration mode, commands and data can be input into the machine by a combination of keyboard data entry and bar code commands. An operator gains authorisation to the configuration screen by presenting their own identification bar code to the bar code scanner. A batch card, containing bar code items is used for inputting a part number and a batch number.

There are illustrated process steps carried out for configuration of the system to set the machine up for applying a run of marks to a set of components. In step 1400, a pre-marked component is loaded onto the machine by mounting it on the mounting device. In step 1401, using a keyboard and/or pointing device, a menu item for a configuration routine is selected. In step 1402 a part type is selected from the list displayed in the component number list 1301. The component types are pre-entered using a separate software module. In step 1403 the Data Matrix contents for that particular part type are entered. In step 1404, a manufacturer code is entered for the selected component type. In step 1405 a verification frequency is entered. The verification frequency specifies whether verification occurs for every mark (verification=1), or for example for every fifth mark applied (verification=5). In step 1406, a live camera mode is started by activating the start live icon 1313. In step 1307, the camera is positioned, and the focus checked in step 1407. If the result is acceptable in step 1408, then the operator can apply that set of configuration data by activating ‘apply’ icon 1312 in step 1409.

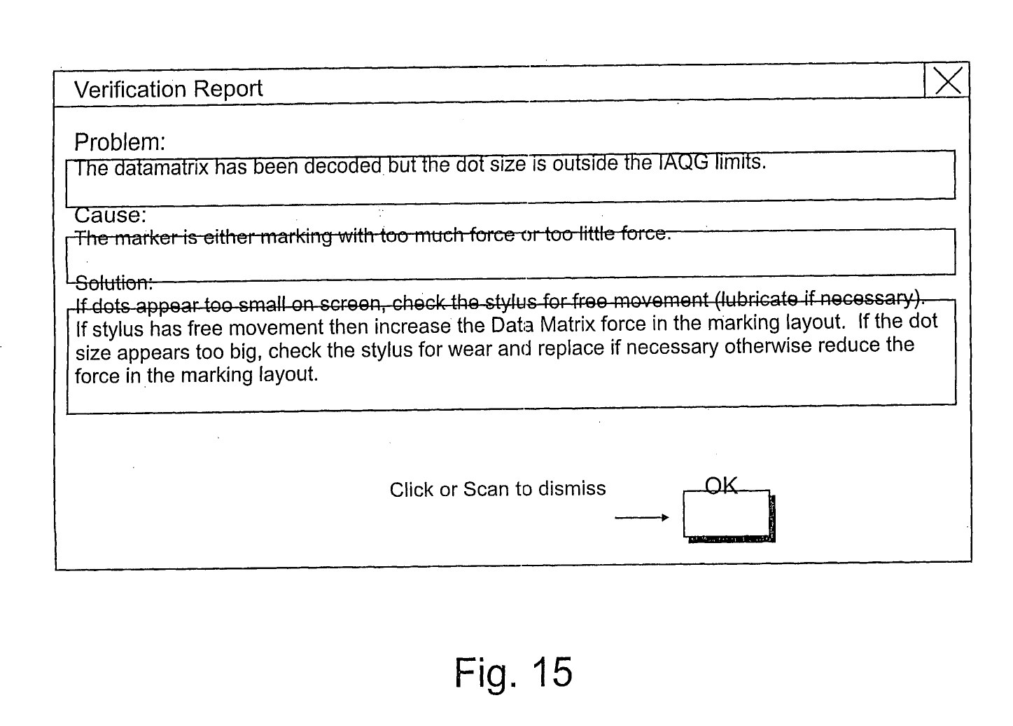

Referring to FIG. 15 herein, there is illustrated schematically a verification report display interface generated by the system, when an applied mark has been analysed by the system condition component, with the result that the mark has found to deviate from an ideal set of parameters to an extent which triggers an alert warning.

The verification display comprises a first text window 1501 containing text data describing a problem which has been found with the mark; a second text window 1502, displaying a text information describing a cause of the problem; and a third text window 1503 displaying text describing a solution to the problem.

In the best mode implementation, the verification component generates five verification result messages, which are stored in a look up table along with text data describing a problem, a cause and a solution for each of those generated messages. Generation of the appropriate message causes look up of the appropriate corresponding text in the look up table, which is displayed in the verification report display. In the best mode, the following messages, and their corresponding text is stored:

[Decode Failure]

Problem=Camera unable to decode the Data Matrix code

Cause=The camera may not be positioned at the correct focal point, the Data Matrix may not be fully in camera view

Solution=Check the captured image on screen to ensure the Matrix is in view and the camera is focused. If not use the Configure→Parts dialogue to ensure the part is set up correctly.

[Locate Failure]

Problem=Camera unable to locate the Data Matrix code

Cause=The camera may not be positioned at the correct focal point, the Data Matrix may not be fully in the camera view

Solution=Check the captured image on screen to ensure the Matrix is in view and the camera is focused. If not use the Configure→Parts dialogue to ensure the part is set up correctly. [Dotsize Failure]

Problem=The Data Matrix has been decoded but the dot size is outside the specified limits

Cause=The marker is either marking with too much force or too little force.

Solution=If dots appear too small on screen, check the stylus for free movement (lubricate is necessary). If stylus has free movement then increase the Data Matrix force and in the marking layout. If the dot size appears to big, check the stylus for wear and replace is necessary, otherwise reduce the force in the marking layout

[Centreoffset Failure]

Problem=the Data Matrix has been decoded by the dot centre offset if outside the specified limits.

Cause=Some of the Data Matrix dots are not positioned on the ideal ‘grid’ arrangement. The marking head may need some mechanical attention

Solution=Check for ‘play’ in the marking head mechanics and correct if necessary. Check the stylus, slug and nosepiece are not worn, replace is necessary.

[Distorionangle Failure]

Problem=The Data Matrix has been decoded but the distortion angle of the matrix is outside the specified limits.

Cause=The Data Matrix code has distortion on the ‘L’ angle. The marking head may need some mechanical attention

Solution=Check for ‘play’ in the marking head mechanics and correct is necessary. Check the stylus, slug and nosepiece are not worn, replace if necessary.

Generation of the verification reports is achieved by storing these reports as an initiation file in the controller.

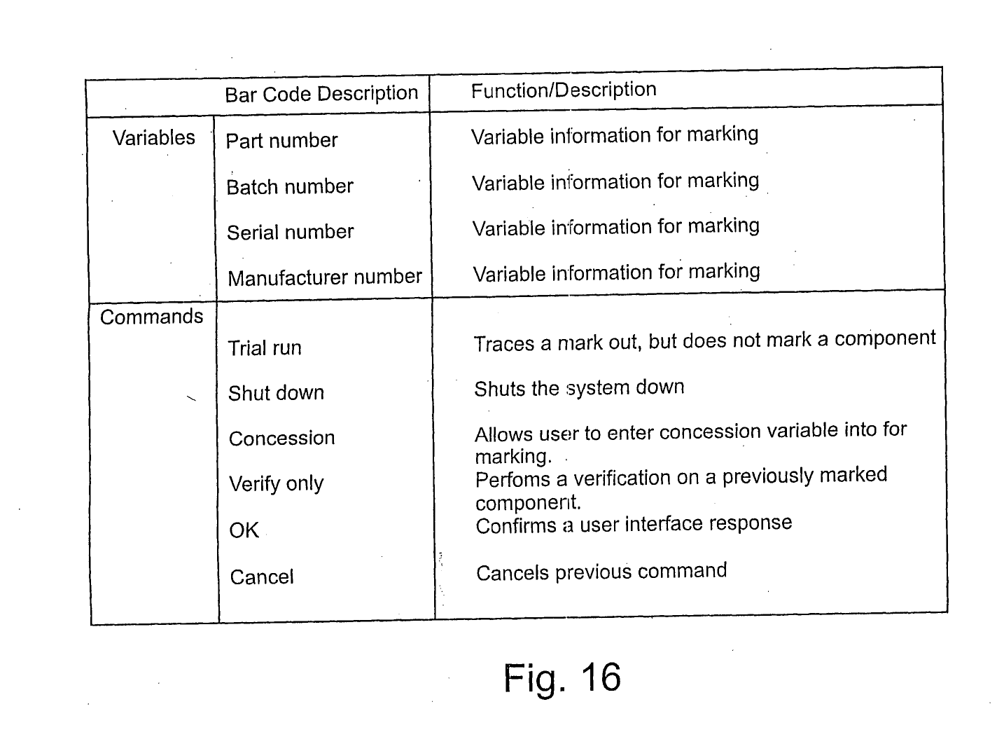

Referring to FIG. 16 herein, there is illustrated schematically a table describing bar code variables and commands, and their associated functions and descriptions.

The bar code processor 502 recognises bar codes having the format according to the bar code descriptions in FIG. 16. The bar code processor receives bar code signals input from the bar code scanner, and acts upon them if they are in a recognised format according to the descriptions listed in FIG. 16. Variables include; a part number variable; a batch number variable; a serial number variable, and a manufacturer number variable.

Commands include the ‘trial run’ command; a ‘shutdown’ command; a ‘concession’ command; a ‘verify only’ command; an ‘OK’ command; and a ‘cancel’ command.

The ‘trial run’ command causes the device marker to trace out the mark, but without actually marking the component. The ‘shutdown’ command causes the system to shut down. The ‘verify only’ command causes the system to perform a verification function on mark, without marking. The ‘concession’ command causes the system to overwrite an incorrect mark.

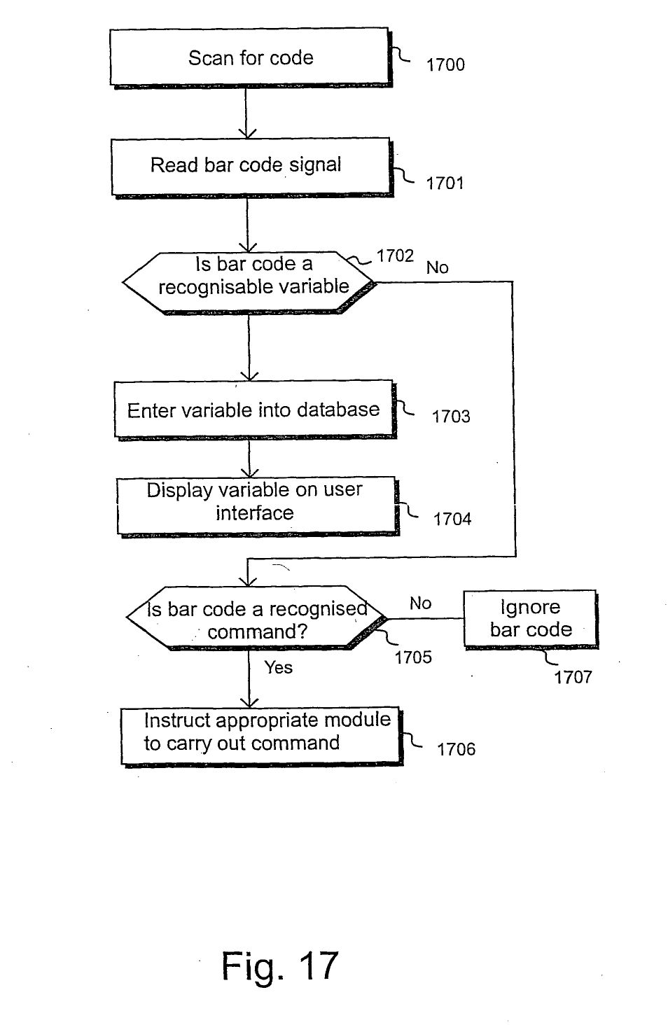

Referring to FIG. 17 herein, there is illustrated schematically process steps carried out by the bar code processor and control application for acting on scanned in bar codes. In step 1700, an operator scans in a bar code using the bar code reader. The signal produced by the bar code reader is read by the bar code processor in step 1701. Providing the bar code is a recognisable bar code, and is recognised as a variable, then in step 1703, the control application enters the variable into the database, and in step 1704 displays the variable on the user interface. If the bar code is recognisable as a bar code, but is not a recognised variable, then it is checked whether it is a recognised command in step 1705 by the control application. If the bar code is a recognised command, then the control application instructs the appropriate module to carry out the command in process 1707. If the bar code is not a recognised command, then the control application ignores the bar code signal 1707.

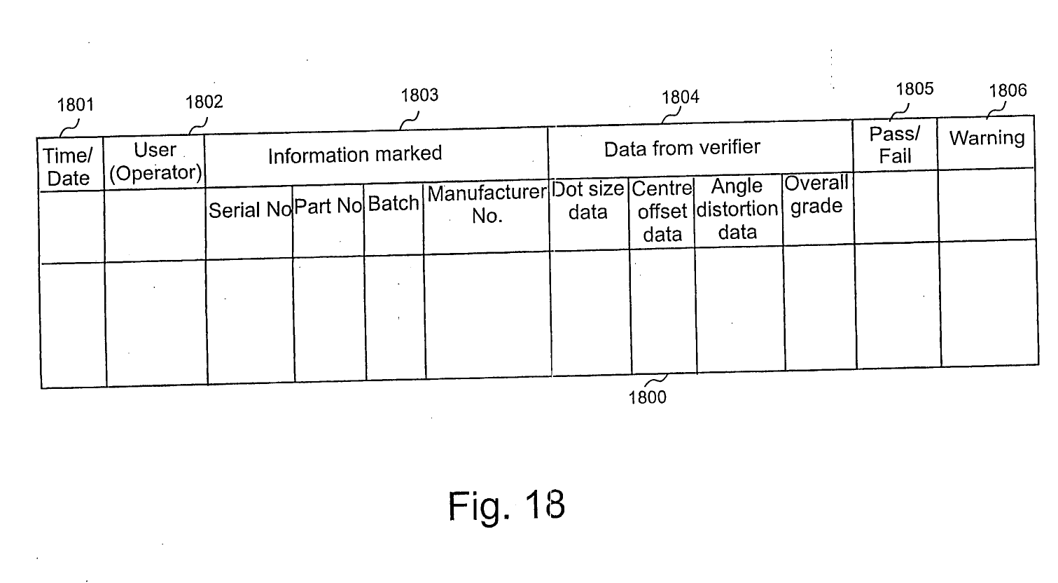

Referring to FIG. 18 herein, there is illustrated schematically data fields stored in database 502. The data fields include a time/date field 1801; an operator field 1802 for recording an operator of the system at a specified time and date; a marked information field 1803, sub-divided into individual fields detailing the information which has been applied within a mark at a specified, time and date, including fields for serial number, part number, manufacturer number, and batch number; a verification data field 1804, comprising data received from the verifier component including a dot size data, a centre offset data, an angle distortion data, an overall grade data; a verification result field 1805 indicating a pass/fail result of a verification process; and a warning field 1806 indicating whether a maintenance alert condition is generated

The database allows checking for duplicate markings to be made. Where a part is to be marked with a serial number, part number, manufacturer number and batch number, which is newly input into the system, these details can be checked against existing records of part number, serial number, manufacturer number and batch number marks, to ensure there is no duplication, and that every mark applied by the marking system is unique.

Each row of the database stored information describing a signal mark applied to a component. It is not necessary that every mark applied by the machine is verified, therefore for some marks, the verification data field 1804, pass/fail field 1805 and warning field 1806 may contain null data. This may be indicated as a row of ‘X’. The time and date field 1801, operator field 1802 and the information marks field 1803 may still be completed, indicating that that mark has been applied, however the verification and maintenance data may be shown as unobtainable by the row of ‘X's’. From the null entries in the database, it can be determined that not every mark has been selected for verification in that particular run of marks.

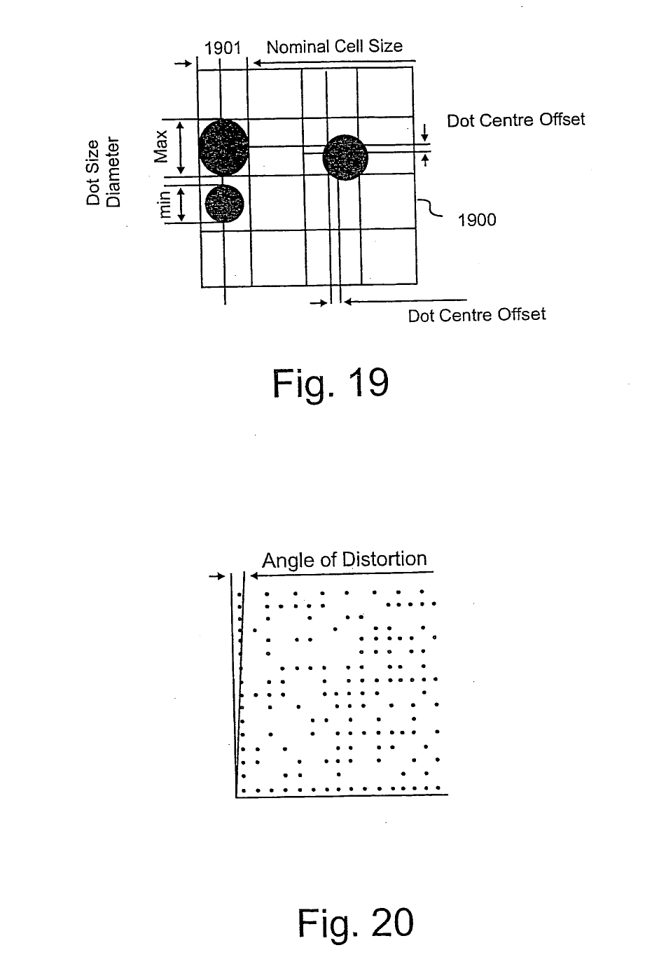

Referring to FIG. 19 herein, there is illustrated schematically in graphical form, some of the data types stored in the database. A Data Matrix mark is applied as a set of dots arranged within a nominal grid 1900 of squares, where each square either contains a dot or does not contain a dot, representing a digital ‘0’ or ‘1’ signal within that square. Each square cell has a nominal cell size 1901. Errors which can occur are distortion of the grid itself, which results in misplacement of dots within the ideal un-distorted grid, over-sized or under-sized dots, misshapen dots, and dots placed off centre in a cell, possibly overlapping adjacent cells. Monitoring the dot size diameter can be used to indicate erratic stylus punching, a worn stylus which gradually changes over time, or a chipped stylus, which results in a step change in dot size diameter.

Monitoring dot centre off set can indicate a worn carriage mechanism, a worn stylus guide, and/or worn fixturing.

Referring to FIG. 20 herein, there is illustrated schematically a distorted mark. The dots of the mark do not lie within a truly square grid, but lie within a distorted grid, where individual cells are quadrilateral shaped and are not true square.

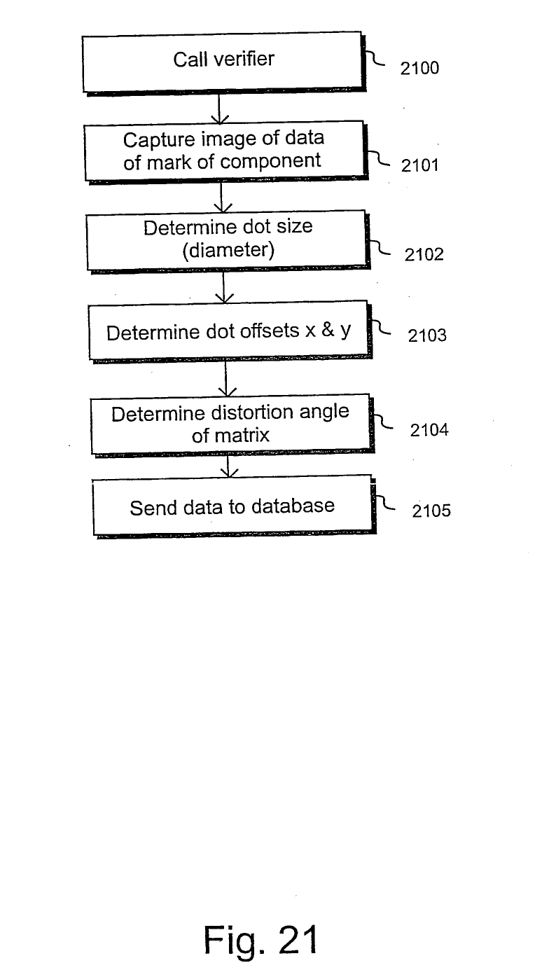

Referring to FIG. 21 herein, there is illustrated schematically process steps carried out by verifier component 506 for reading a mark. The verifier component receives a call from the control application to verify a mark. On receiving the call, the verifier component 2101 activates the camera to capture an image data on component. From the captured image data, the verifier component determines a dot diameter in step 2102, and determines dot off set data in step 2103 and determines the distortion angle of the Data Matrix. In step 2104, the verifier component sends the data to the control application for storage in the database.

If a mark cannot be read and decoded, then the control application generates a fail signal which is displayed on the interface using the fail indicator. However, for marks which are decodable and readable, but which are still tending towards an out of limit condition, these give rise to a maintenance signal on the interface display as described previously. The maintenance signal is generated by the system condition component 505.

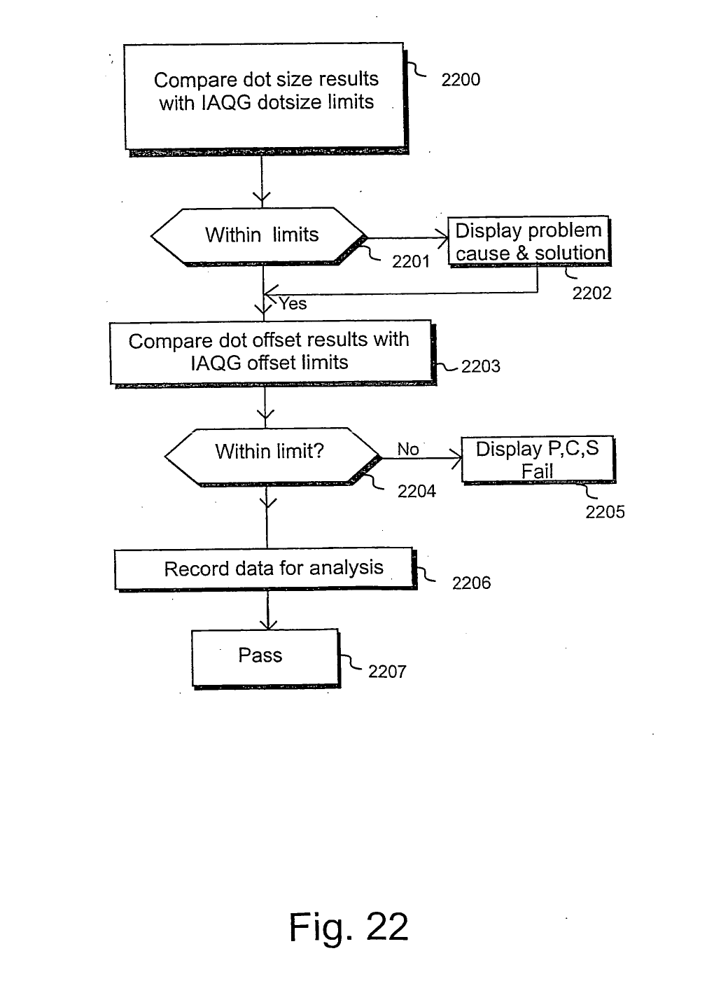

Referring to FIG. 22 herein, there is illustrated schematically a first mode of operation of system condition component 505. The system condition component monitors the status of the system, by inspecting the output signals from the verification component 506 and analysing that output to check for known defective conditions which the system may encounter, for example worn carriages, worn stylus, erratic stylus punching, worn stylus guide, or chipped stylus.

When the verifier component is called, the data available include dot size data, dot centre off set data, and angle of distortion. The verifier component also gives three grades of result. A grade ‘A’ indicates excellent quality, grade ‘B’ indicates acceptable quality, and grade ‘F’ which indicates a failure (i.e. an unacceptable quality and that the mark is outside the specified tolerance limits for readability). The system condition component inputs the output from the verifier component, and in step 2200 compares the dot size data result with the specified dot size limits. If, in step 2201 the dot size is outside the specified limit, then is step 2202, the system displays a verification report listing a problem, cause and solution, and also generates a fail indicator. If the dot size is within limits in step 2201, then in step 2203, the status condition component compares the dot off set data with the specified dot off set limit data. If in step 2204, the dot off set results from the verifier are outside the specified dot off set centre limits then in step 2205, a fail message is generated and displayed, and a verification report detailing a problem, cause and solution text is generated. If in step 2204, the dot off set data from the verifier component is within the specified dot off set limits, then in step 2206 the status condition component compares an angle of distortion result output from the verifier component with the specified angle of distortion limits. If in step 2207 the angle of distortion result output from the verifier is outside the specified limits, then in step 2208 the system generates the fail message which is displayed, and also displays a verifier report detailing the problem, cause and solution for the failure, if in step 2207 the angle of distortion data is within the specific limits for that parameter, then in step 2209 the system records the data for analysis and in step 2210 generates a pass signal.

The verification software examines the Data Matrix code. The verifier software is preset to expect in this example, a 16×16 dot code and expects certain parameters for that Matrix due to the size of the Matrix. The software can calculate an ideal size for the dots and an ideal dot centre off set. If the measured dot size is greater than or smaller than the ideal, the Matrix will be failed.

If a fail result is generated by the verifier, then the status condition component, which comprises a state machine, can determine which problem, cause and solution to display. For example, if the dot size has produced a failure, then this is because the dots are either too large or too small for the machine.

Taking as an example a best case, where the mark passes the verification in step 2200 if the dot size results from the verification component are within limits in step 2201, then in step 2203 the dot off set result is compared with the specification for that parameter. In step 2204, the dot off set result is within the specified limit, so the system proceeds in step 2206 to compare the angle distortion results with the specified limit for that parameter. In step 2207, the angle distortion in within the specified limit, therefore in step 2209 the system records the data for analysis in the database, and generates a pass signal in step 2210.

Supposing that the mark passes the test for dot size, and dot off set, but fails the angle distortion test, then in step 2208 the message [DISTORTIONANGLE FAILURE] would be generated, detailing the problem, cause and solution for that of failure.

The simplest output from verifier component are the levels A, B and F as described as described herein above. For each of the parameters, dot size, dot off set and angle distortion, a separate indicator A, B and F is generated by the verifier component. The verifier also outputs the following:
a first dot size count, representing the number of cells which have dots which are below 70% of the ideal dot size, or the number of cells having dots which are above 90% of the cell size;
a second dot size count, representing the number of cells which are smaller than 60% or greater than 100% of the nominal cell size.

If there are too many dots in count 1, then a grade B will be generated. If there is any more than a predetermined number in count 2, then a grade F signal will be generated, therefore, if there is more than a predetermined percentage of dots outside the wider tolerance limit (the count 2 criteria), then a fail signal will be generated.

Similar first and second counts are generated for the parameter of dot centre off set. That is, a first dot centre off set count indicating the number of dots which are outside an ideal dot centre by a first specified limit is generated. Also a second dot centre off set count specifying a number of dots outside a second, and wider, dot centre off set limit is generated. Each of the first and second dot size counts and first and second dot centre off set counts resulting from the verification process of the mark are stored in the database record for that mark.

For the parameter of dot size, there is generated a grade A, B, F and first and second counts of dot size. Similarly for dots in off set, there is generated a grade data A, B, F as well as a first and second count of dot centre off set.

For the first count for dot centre off set, this represents the percentage of cells whose dot off set exceeds 10% of the nominal cell size. The second count represents the percentage of cells whose dot centre exceeds of the nominal cell size. If either of the first or second count are more than 2% of dots, then that count number will generate a fail signal.

Additionally, further parameters may be output from the verifier component, which can be analyzed to check for growth of dot size over successive marks. If the dot size grows or shrinks, this can indicate a chipped or worn stylus. A further output of the verification component gives account of a number of errors which have been corrected within the error correction code embedded within the dot matrix. The amount of error correction required to decode a mark can be used as a parameter, to indicate the overall condition of the machine.

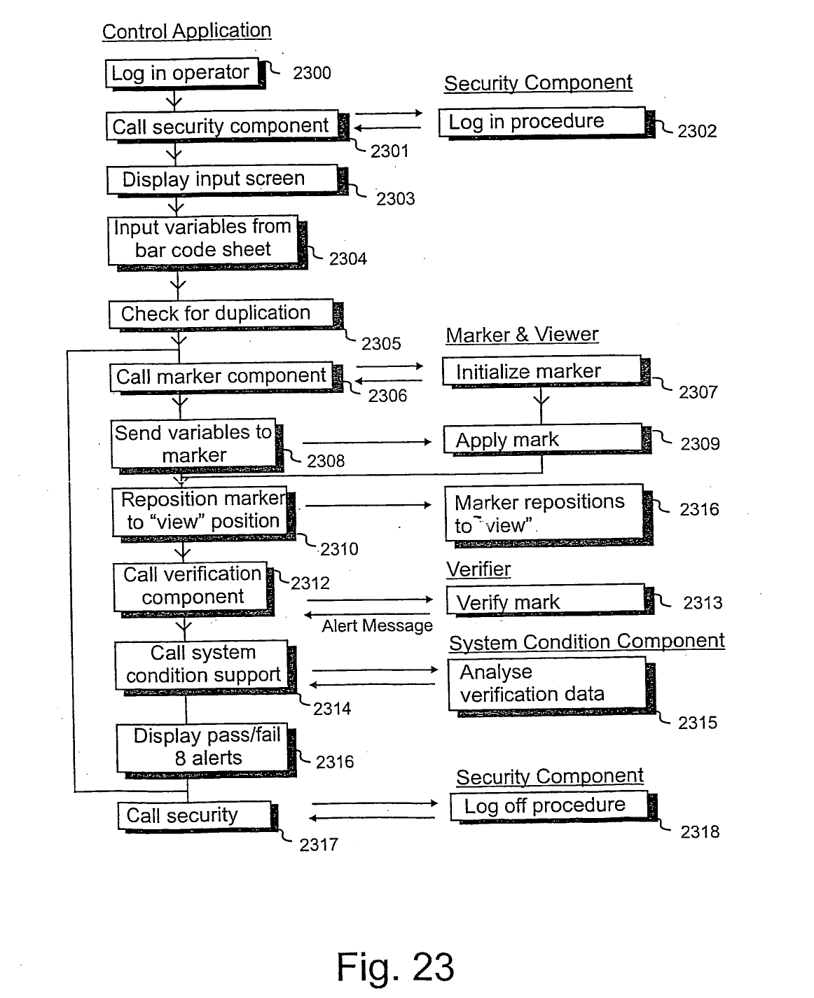

Referring to FIG. 23 herein, there is illustrated schematically a mode of operation of the control application for overall control of the system, for applying a series marks to a series of components. In process 2300 an operator requests log in to the system by scanning a bar code identifying the operator using the bar code scanner. The control application calls the security component in process 2301. The security component carries out a log in procedure in process 2302. Provided the operator presents a bar code identification which matches a list of authorised operators stored in the database, then the operator is accepted by the system. The system displays the configuration screen for setting up a run of marks in step 2303. The operator then proceeds to input a set of variables into the system by scanning those variables from the bar codes menu in step 2304. The variables can include part number, batch number, and manufacturer identification number and serial number. In process 2305, historical data stored in the database, of previous marks applied is checked, to see if the new set of variables and part number is a duplication of any previously applied mark. Provided the new variables input into the system will not result in duplication of marks, in step 2306, the marker device is called by the control application. Upon calling the marker device, the marker initializes, by loading the variables, in order to commence a run of applying marks in process 2308. The marker proceeds to input the first mark in process 2309. Upon completing a mark, the control application sends a signal to the marker device to reposition the marker and viewer device to a view position in step 2310. The camera generates an image data, which is automatically input into the verification component. The control application calls the verification component in step 2312 and in step 2313, the verification component commences a verification operation, to analyse the image of the mark, and to verify whether the mark has passed or failed to be read. If the mark is successfully decoded and can be read, then the verification component generates a ‘pass’ signal. If the verification component cannot read the mark, then it generates a ‘fail’ signal. The pass/fail signal is displayed on the visual display device in step 2316. In process 2314, the control application calls the system condition component, to initiate checking of the verification data or output from the verification component, to see whether maintenance of the system is required. The condition component analyses the verification data in process 2315 and if any of the verification data is outside a pre-determined limit, an alert message is generated, which the control application displays as a verification report.

If either a fail signal is displayed and/or if an alert signal is displayed, the operator can input a ‘verify only’ bar code command from the command set, which causes the verification component to repeat the verification process. The mark may either pass or fail on the repeat of the verification process. The operator can check that the mark is being viewed correctly by the camera and is in focus, using the image display on the visual display device. A mark which is shown as having failed the verification process may subsequently be able to pass the verification process, if the focus of the camera is readjusted slightly. Similarly, if an alert signal is generated for a mark, then the operator may wish to check whether that alert signal has been generated because the camera is slightly out of focus, and can repeat the verification process by inputting the ‘verify only’ command.

For subsequent components, marks can be applied and verified by repeating the processes 2306 to 2316 as described above. After a run of components have been marked with a set of consecutive and unique marks, the operator logs off the marking system. The control application calls the security component in process 2317 which operates a log off procedure in process 2318.

1. An integrated marking system for marking components, said system comprising;
a marking device for applying a mark directly to a component;
an image capture device for capturing an image of said mark;
a verification device for verifying an integrity of said mark, and
a common control system for controlling said marking device, said image capture device and said verification device.

2. The system as claimed in claim 1, wherein, before release of said component from said system occurs, said component undergoes:
a marking operation; and
a verification operation resulting in confirmation of a pass/fail condition of said mark.

3. The system as claimed in claim 1, wherein:
said marking device and said image capture device are mounted on a stage: and
said system further comprise a mounting capable of securely holding said component; wherein
said stage and said mounting are positionable relative to each other between a first position in which said marking device can apply a mark to a component held in said mounting, and a second position in which said image capture device can capture an image of said applied mark.

4. The system as claimed in claim 1, wherein
said marking device and said image capture device are mounted on a moveable stage; and
said system further comprise a mounting capable of securely holding said component; wherein
said stage and said mounting are positionable relative to each other between a first position in which said marking device can apply a mark to a component held in said mounting, and a second position in which said image capture device can capture an image of said applied mark;
said stage comprising;
a first moveable carriage capable of moving along a first line of movement;
a second moveable carriage capable of moving along a second line of movement, said first line of movement being transverse to said second line of movement;
a mounting plate connected to said second carriage, such that movement of said first and second carriage along said first and second lines of movement moves said mounting plate in a first plane of movement; and
said image capture device and a tool holder device for holding a marking tool are mounted to said mounting plate.

5. The system as claimed in claim 1, wherein said common control system comprises a user interface,

6. The system as claimed in claim 1, wherein said mark comprises a machine readable code.

7. The system as claimed in claim 1, further comprising:
a bar code scanner; and
a bar code processor device,
said bar code scanner and said bar code processor device operable for receiving commands and data inputs in the form of bar codes.

8. The system as claimed in claim 1, further comprising:
a visual display device, said visual display device configured for displaying at least one display interface; and
an indicator display for indicating whether a mark has passed or failed a verification test.

9. The system as claimed in claim 1, further comprising:
a visual display device having an image display capable of displaying in real time an image of said mark.

10. The system as claimed in claim 1, further comprising;
a set of printed bar code commands for controlling said system.

11. The system as claimed in claim 1, further comprising:
a security component, said security component operable for:
inputting a data identifying an operator of said system;
checking whether said operator is authorised to operate said system; and
if said operator is authorised to operate said system, enabling said system to be operated by input of a set of commands.

12. The system as claimed in claim 1, further comprising:
a security component, said security component operable for inputting a data identifying an operator of said system;
comparing said input identification data with a set of pre-stored identification data; and
depending upon a result of said comparison, enabling said apparatus to operate according to a set of privileges corresponding to said input operator identification data.

13. An integrated method of applying a mark to a component, and verifying said mark, said method comprising:
applying said mark to said at least one component;
capturing an image of said applied mark; and
verifying whether said mark is within a specified tolerance;
wherein said processes of applying said mark, capturing said image, and verifying said image are carried out by a common control system.

14. The method as claimed in claim 13, further comprising:
displaying parameters describing said processes on a common user interface.

15. The method as claimed in claim 13, wherein:
a pass/fail indicator;
a set of underlying data from which said pass/fail indicator is determined; and a unique component identifier are stored as a data record.

16. The method as claimed in claim 13, further comprising the step of:
inputting a set of marking data types to be applied to said component as said mark, said data type selected from the set:
data identifying a manufacturer;
a serial number;
a part number;
a batch number.

17. The method as claimed in claim 13, wherein said step of verifying said image comprises:
analysing a dot centre off set parameter of one or a plurality of dots comprising said image;
analysing a dot size parameter of one or a plurality of dots comprising said image; and
analysing a distortion of a plurality of dots comprising said image.

18. The method as claimed in claim 13, wherein said step of applying said mark occurs as a first operation, and said steps of capturing an image of said mark and verifying said mark occur as a second operation,
wherein said first and second operations are carried out sequentially under control of said common control system.

19. The method as claimed in claim 13 further comprising:
displaying said captured image of said applied mark on a visual display device in real time.

20. The method as claimed in claim 13, further comprising:
generating a pass/fail indicator signal as an output result of said verification.

21. The method as claimed in claim 13, further comprising:
performing a further analysis of said captured image, and generating as a result of said further analysis, a signal representing a maintenance status of a marking device.

22. The method as claimed in claim 13, further comprising:
performing a further analysis of said captured image, and generating as a result of said further analysis, a signal representing a maintenance status of a marking device; and
displaying said maintenance output signal as a visual display.

23. An integrated method of applying a mark to a component, and verifying said mark, said method comprising:
inputting a set of marking data to be applied in the form of a mark to at least one component;
applying said mark to said at least one component;
capturing an image of said applied mark;
analysing said captured image to verify whether said mark is within a specified tolerance; and
analysing said captured image to determine a maintenance status of said apparatus.

24. A control system for a combined marking and verification apparatus, said operating system comprising;
a control application for controlling overall operation of said apparatus;
a bar code processor capable of receiving bar code inputs for control of said apparatus;
a security component, capable of authorising an operator of said apparatus;
a verification component capable of verifying a mark applied by said apparatus;
a system condition component capable of monitoring a maintenance condition of said apparatus; and
a database for storing data for operation of said apparatus.

25. The control system as claimed in claim 24, wherein said database stores data selected from the set;
a time and date data;
data describing an operator of said apparatus;
data describing an information content of a mark;
verification data describing a set of verified parameters of a mark.

26. The control system as claimed in claim 24, wherein said verification component verifies said mark according to tolerance data selected from the set:
dot size diameter tolerance data:
dot centre off set data.

27. The control system as claimed in claim 24, wherein said system condition component comprises:
means for inputting an image data of a mark:
means for analysing said image data to determine a dot centre off set of each of a plurality of dots represented by said image data:
means for determining a dot size for each of a plurality of dots represented by said image data:
means for comparing said dot centre off set with a pre-set limit of dot centre off set:
means for comparing said dot size with a pre-set limit of dot size:
means for generating a warning signal depending on an output of said comparison means, wherein a said warning signal is generated if a said dot centre off set or a said dot size diameter exceeds a said corresponding pre-set limit.

28. The control system as claimed in claim 24, further comprising a display driver, said display driver capable of generating a visual display comprising:
a pass/fail indicator for indicating a result of a verification process;
an image view.

29. The control system as claimed in claim 24, further comprising a display driver, said display driver capable of generating a visual display comprising:
an image display for displaying an image of said applied mark;
a positioning interface for positioning an image capture device to capture said image of said applied mark; and
a mark content display for displaying a set of data variables for inclusion in a set of marks.

30. A configuration method for configuring a component marking system to apply at least one mark to a component, and to verify said mark, said method comprising:
inputting a set of data variable types to be included in a set of marks;
positioning an image capture device to capture an image of a mark;
performing a verification operation for verifying a machine readability of said mark.

31. The method as claim in claim 30, wherein said step of positioning said image capture device comprises:
viewing an real time image of a mark on a display interface.

32. A security method for controlling operation of a marking apparatus capable of applying a mark to a component, said method comprising;
storing a set of operator identifications, each having a corresponding set of privileges for enlisting different operator of said apparatus to be performed;
inputting a bar code signal identifying an operator;
comparing said operator identification signal with said set of stored operator identification signals,
enabling said apparatus to operate according to said corresponding set of privileges corresponding to said input operator identification signal.

33. The method as claimed in claim 32, wherein said privileges enable operations selected from the set;
configuration of said apparatus for applying a set of marks;
operating said apparatus for applying a set marks.

34. An interface display for operating a marking and verification apparatus for applying at least one mark to at least one component, and for verifying said applied at least one mark, said interface comprising;
a pass/fail indicator for indicating a result of a verification process;
an image view for viewing an image of said applied mark; and
a data display for displaying a marking data, subject of said applied mark.

35. An interface display for configuration of a marking and verification apparatus, said interface comprising;
an image display for displaying an image of said applied mark;
a positioning interface for positioning an image capture device to capture said image of said applied mark; and
a mark content display for displaying a set of data variables, for inclusion in a set of marks.

36. The interface as claimed in claim 35, further comprising;
a component type display, for displaying a plurality of component types for which data variables are stored.

37. The interface as claimed in claim 35, further comprising;
a verification frequency display for displaying a frequency of operation of a verification process applied by said machine.

38. A method of monitoring a maintenance condition of a marking machine, said method comprising:
capturing an image of a mark applied to a component;
analysing said captured image to determine whether said mark is within a set of specified limits, within which said machine is operating without the need for maintenance; and
if said analysis results determine that said mark is outside said specified limits, generating at least one message indicating that machine maintenance is required.

39. The method as claimed in 38, wherein said step of analysis comprises:
analysing a dot centre off set parameter of at least one dot comprising said mark.

40. The method as claimed in 38, wherein said analysis comprises:
analysing a dot size of at least one dot comprising said mark.

41. The method as claimed in claim 38, wherein said step of analysis comprises:
counting a number of dots which have a diameter outside a pre-determined limit.

42. The method as claimed in claim 38, wherein said step of analysis comprises:
counting a number of dots of said mark which have a centre off set by more that a pre-determined dot centre off set limit.

43. The method as claimed in claim 38, wherein said step of analysis comprises:
determining an angle of distortion of an array of dots comprising said mark

44. The method as claimed in claim 38, wherein said message comprises:
a text message identifying a problem with said machine;
a text message identifying a cause of said problem; and
a text message identifying a solution to said problem.

45. The method as claimed in claim 38, wherein said generated message is selected from the set:
a decode failure message indicating that a mark code is unable to be decoded;
a locate failure message indicating that a mark code is unable to be located;
a dot size failure message, indicating that a dot size of a mark is outside a specified limit;
a centre off set failure message, indicating that a dot centre off set of a mark is outside a specified limit; and
a distortion angle failure message indicating that a distortion angle of a mark is outside a specified limit.

46. The method as claimed in claim 38, further comprising displaying at least one said message as a visual display.

47. An integrated marking system for marking an engineering component, said system comprising;
a marking device capable of applying a mark directly to a surface of said component;
an image capture device for capturing an image of said mark applied to said component;
a verification device for verifying an integrity of said mark applied directly to said engineering component, and
a common control system for controlling operation of said marking device, said image capture device and said verification device, to perform an operation in which a mark is applied to a said component, an image of said mark is captured, and a verification process is carried out on said image of said mark, to determine whether said applied mark is within a specified tolerance.

48. The integrated marking system as claimed in claim 47, configured for marking an aircraft component.

49. An integrated method of applying a mark to an engineering component, and verifying that said applied mark is within a predetermined tolerance specification, said method comprising:
inputting a set of marking data to be applied in the form of a mark to said component;
applying said mark directly to said engineering component;
capturing an image of said applied mark; and
analysing said captured image to verify whether said applied mark is within said predetermined tolerance specification.

50. The method as claimed in claim 49, wherein said mark is applied to an aerospace component.
